(19) United States
(12) Patent Application Publication
(10) Pub. No.: US 2017/0279329 A1
(43) Pub. Date: Sep. 28, 2017

(54) ELECTRIC MACHINE THERMAL MANAGEMENT

(71) Applicant: Ford Global Technologies, LLC, Dearborn, MI (US)

(72) Inventors: Prasad Dev HANUMALAGUTTI, Dearborn, MI (US); Michael W. DEGNER, Novi, MI (US); Edward Chan-Jiun JIH, Troy, MI (US); Tienli WANG, Troy, MI (US)

(21) Appl. No.: 15/082,093

(22) Filed: Mar. 28, 2016

(51) Int. Cl. H02K 5/20; H02K 9/19

(52) U.S. Cl. CPC H02K 5/20; H02K 9/19

(57) ABSTRACT

A system for a vehicle includes a transmission housing, and an electric machine including a stator core disposed within the housing such that the housing and core define a channel circumscribing a body of the core. The channel is configured to circulate pressurized transmission coolant and to permit seepage of the coolant into a clearance between the housing and core caused by surface roughness of the housing and core to envelop the core with the coolant.

### TECHNICAL FIELD

The present disclosure relates to thermal management systems for electric machines of electrified vehicles.

### BACKGROUND

Extended drive range technology for electrified vehicles, such as battery electric vehicles (“BEVs”) and plug in hybrid vehicles (“PHEVs”), is continuously improving. Achieving these increased ranges, however, often requires traction batteries and electric machines to have higher power outputs, and associated thermal management systems to have increased capacities in comparison to previous BEVs and PHEVs.

### SUMMARY

A system for a vehicle includes a transmission housing, and an electric machine including a stator core disposed within the housing such that the housing and core define a channel, circumscribing a body of the core, configured to circulate pressurized transmission coolant and to permit seepage of the coolant into a clearance between the housing and core caused by surface roughness of the housing and core to envelop the core with the coolant.

A coolant circulation system for a vehicle includes a transmission housing having an inner surface defining a cavity for receiving a stator core, and defining a channel configured to circulate pressurized transmission coolant about a portion of the core and to permit seepage of the coolant into a clearance between the inner surface and core to envelop the core with the coolant.

A system for a vehicle includes a pump configured to circulate coolant through a network of passages. At least one of the passages is a channel defined by an inner surface of a transmission housing and an outer surface of a stator core. The channel permits seepage of the coolant into a clearance between the inner surface and core caused by a difference in roughness of the inner surface and core to envelop the core with the coolant.

### BRIEF DESCRIPTION OF THE DRAWINGS

FIG. 1 is a block diagram illustrating an example of an electrified vehicle;

FIG. 2 is a perspective view of an example of an electric machine and a housing;

FIG. 3 is a perspective view of a housing for an electric machine, such as the electric machine of FIG. 2;

FIG. 4A is a side view, in cross-section, of a portion of the electric machine of FIG. 2;

FIG. 4B is a detailed view, in cross-section, of a portion of the electric machine of FIG. 2;

FIG. 5 is a side view, in cross-section, of a portion of the electric machine of FIG. 2;

FIGS. 6A-6F are perspective views of a portion of the electric machine of FIG. 2 and housing;

FIG. 7 is a front view, in cross-section, of a portion of the electric machine of FIG. 2;

FIGS. 8A-8B are top views of a portion of the electric machine of FIG. 2;

FIGS. 9A-9C are front views, in cross-section, of a portion of the electric machine of FIG. 2; and

FIG. 10 is a front view of a portion of the electric machine of FIG. 2.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

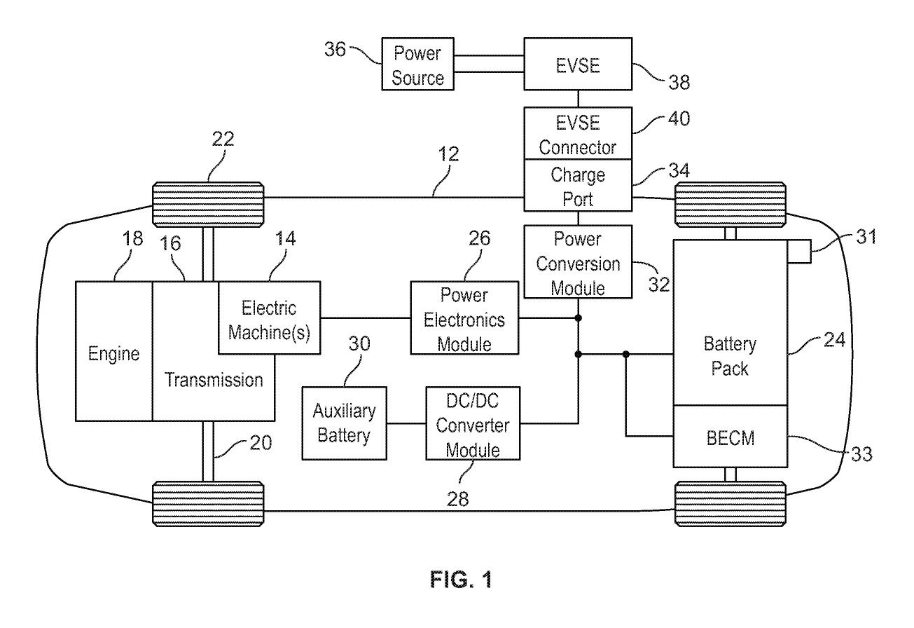

FIG. 1 depicts a schematic of an example of a PHEV, referred to as a vehicle 12 herein. The vehicle 12 may comprise one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off. The electric machines 14 may also act as generators and may provide fuel economy benefits by recovering energy that would normally be lost as heat in the friction braking system. The electric machines 14 may also provide reduced pollutant emissions since the hybrid-electric vehicle 12 may be operated in electric mode or hybrid mode under certain conditions to reduce overall fuel consumption of the vehicle 12.

A traction battery or battery pack 24 stores and provides energy that may be used by the electric machines 14. The traction battery 24 may provide a high voltage DC output from one or more battery cell arrays, sometimes referred to as battery cell stacks, within the traction battery 24. The battery cell arrays may include one or more battery cells. The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may also be electrically connected to the electric machines 14 and provides the ability to bi-directionally transfer electrical energy between the traction battery 24 and the electric machines 14. For example, the traction battery 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. Portions of the description herein are equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A DC/DC converter module 28 may convert high voltage DC output of the traction battery 24 to a low voltage DC supply that is compatible with other vehicle loads. Other high-voltage loads, such as compressors and electric heaters, may be connected directly to the high-voltage without the use of the DC/DC converter module 28. The low-voltage systems may be electrically connected to an auxiliary battery 30 (e.g., 12V battery).

A battery electrical control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24. The temperature sensor 31 may also be located on or near the battery cells within the traction battery 24. It is also contemplated that more than one temperature sensor 31 may be used to monitor temperature of the battery cells.

The vehicle 12 may be, for example, an electrified vehicle which includes components for a PHEV, a FHEV, a MHEV, or a BEV. The traction battery 24 may be recharged by an external power source 36. The external power source 36 may be a connection to an electrical outlet. The external power source 36 may be electrically connected to electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (CAN)) or via discrete conductors.

Thermal management of electric machines may introduce coolant, oil, or another substance to portions of the electric machine for cooling purposes. In one example, coolant or oil may be dripped or sprayed onto wire end windings of the electric machine. In another example, an air cooled thermal management assembly may assist in managing thermal conditions of an electric machine. In such an example, a fan or blower may be located adjacent the end windings to push air thereto for cooling purposes.

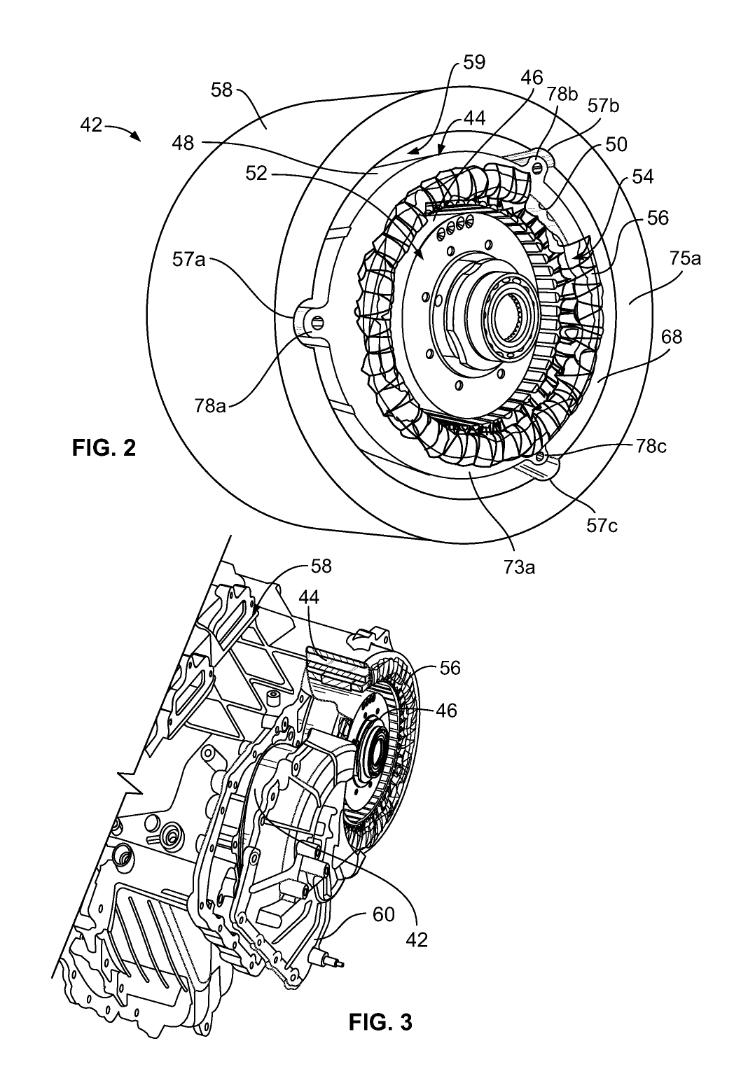

FIG. 2 shows an example of an electric machine for an electrified vehicle, referred to generally as an electric machine 42 herein. The electric machine 42 may include a stator core 44 and a rotor 46. Electrified vehicles may include two electric machines. One of the electric machines may function primarily as a motor and the other may function primarily as a generator. The motor may operate to convert electricity to mechanical power and the generator may operate to convert mechanical power to electricity. The stator core 44 may define an outer surface 48, an inner surface 50, and a cavity 52. The rotor 46 may be sized for disposal and operation within the cavity 52. A shaft (not shown) may be operably connected to the rotor 46 to drive rotation thereof.

Windings 54 may be disposed within the cavity 52 of the stator core 44. In an electric machine motor example, current may be fed to the windings 54 to obtain a rotation force on the rotor 46. In an electric machine generator example, current generated in the windings 54 by a rotation of the rotor 46 may be removed to power vehicle components. Portions of the windings 54, referred to as end windings 56 herein, may protrude from the cavity 52. During operation of the electric machine 42, heat may be generated along the windings 54 and end windings 56.

The electric machine 42 may be disposed in a cavity 59 defined by a housing 58, such that an inner surface 68 of the housing 58 and the outer surface 48 of the stator core 44 define a channel circumscribing a body of the stator core 44 and configured to circulate pressurized coolant. The housing 58 a plurality of recesses 57a-c configured to receive a plurality of mounting points 78a-c defined by the stator core 44 and configured to mount the stator core 44 to the housing 58. The housing 58 defines a front and rear surfaces 75a-b configured to align with corresponding front and rear surfaces 73a-b of the stator core 44. In one example, applying sealant along at least a portion of both the front and rear surfaces 75a-b of the housing 58 and the front and rear surfaces 73a-b of the stator core 44 may define a space between inner surface 68 of the housing 58 and the outer surface 48 of the stator core 44.

FIG. 3 shows an example of the housing 58 configured to retain vehicle components. Examples of vehicle components which may be retained within the housing 58 include the electric machine 42 or a vehicle transmission. A cover 60 may be secured to the housing 58. The cover 60 may be arranged with the stator core 44 such that a cavity is defined by the cover 60 to receive the end windings 56 extending from the stator core 44. For example, the cavity defined by the cover 60 may be sized such that end windings 56 protruding from the stator core 44 may be disposed therein.

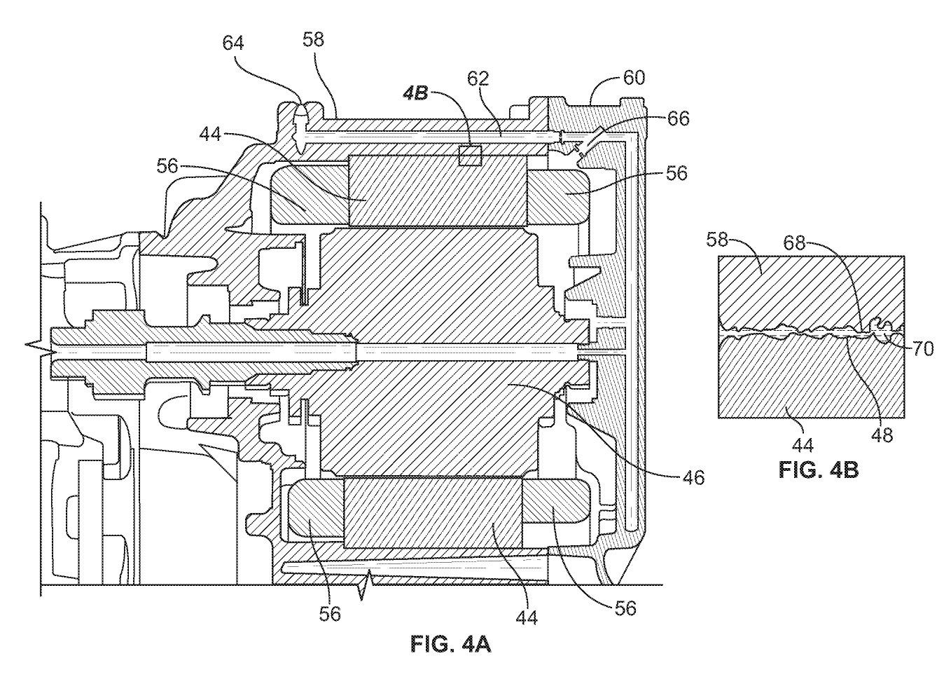

The housing 58 and the cover 60 may further include a network of channels and passages disposed therein for circulating pressurized coolant. In one example, the coolant may be a liquid, such as transmission oil. The coolant may remove heat from one or more portions of the electric machine 42 generated, for example, when an electric current is circulated in a conductor. Shown in FIG. 4A is a passage 62 disposed in the housing 58 and the cover 60. The passage 62 may circulate pressurized coolant to assist in thermal management of the electric machine 42. The coolant may enter the housing 58 at an inlet 64 and circulate through the cover 60 before exiting at an outlet (not shown). A temperature of the coolant exiting the system at the outlet may be higher than it was when the coolant came through the inlet 64. In one example, a temperature of the coolant exiting portions of the electric machine 42 may be lowered by passing the coolant through a heat exchanger (not shown). A transmission coolant pump (not shown) may then again send the coolant through portions of the electric machine 42 repeating the process of thermal management.

The coolant may remove heat by contacting portions of the electric machine 42, such as by dripping onto the end windings 56 through an orifice 66. The end windings 56 may be further cooled using centrifugal impingement, or spray cooling, from the rotor 46. The stator core 44 in thermal contact with the windings 54 may thus be cooled indirectly, such as through contact with coolant being directed into adjacent portions of the electric machine 42. FIG. 4B shows the outer surface 48 of the stator core 44 disposed proximate an inner surface 68 of the housing 58. In one example, the stator core 44 may be toleranced to fit within the housing 58 using a predetermined clearance fit, such as a sliding fit.

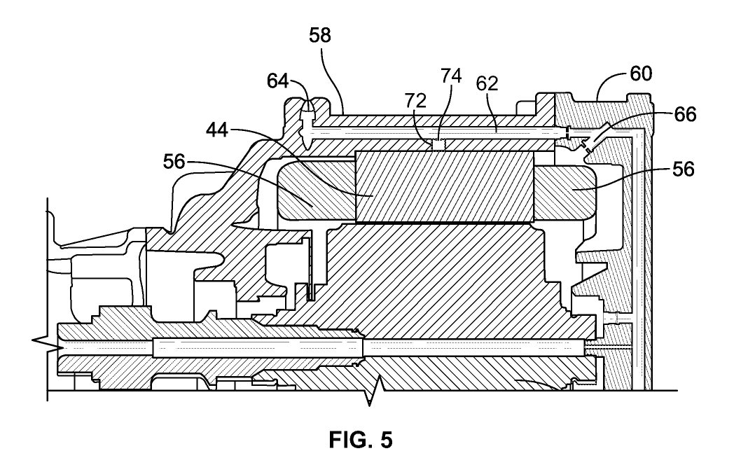

As shown in FIG. 4B, the outer surface 48 of the stator core 44 and the inner surface 68 of the housing 58 may define a clearance 70. In one example, the clearance 70 is defined by a difference in surface roughness of the outer surface 48 of the stator core 44 and the inner surface 68 of the housing 58. Reducing thermal contact resistance between the outer surface 48 and the inner surface 68 may improve thermal management of the stator core 44. For example, introducing pressurized coolant within the clearance 70 may increase amount of heat removed from the stator core 44. In another example, the clearance 70 may accommodate seepage of the coolant thereto, such that the coolant may envelop the stator core 44. As will be described in further detail in reference to FIG. 5, the inner surface 68 of the housing 58 may further define a channel for supplying coolant to the outer surface 48 of the stator core 44.

FIG. 5 shows a side view, in cross section, of a portion of the housing 58 and the electric machine 42. The inner surface 68 of the housing 58 may define a channel 72 therein for supplying pressurized coolant to the outer surface 48 of the stator core 44. The housing 58 may define the channel 72 such that the channel 72 circumscribes the outer surface 48 of a body of the stator core 44 when the stator core 44 is placed inside the housing 58. The housing 58 may further define the channel 72 such that the channel 72 extends along at least a portion of a circumference defining the outer surface 48 of the body of the stator core 44. The pressurized coolant may enter the channel 72 through, for example, a channel inlet 74 defined by the passage 62. The pressurized coolant circulating in the channel 72 is in thermal communication with the outer surface 48 of the stator core 44. Other configurations for defining the channel inlet 74 and the channel 72 are also contemplated. In one example, the channel 72 may permit seepage of the coolant into the clearance 70, such that the coolant envelops the stator core 44.

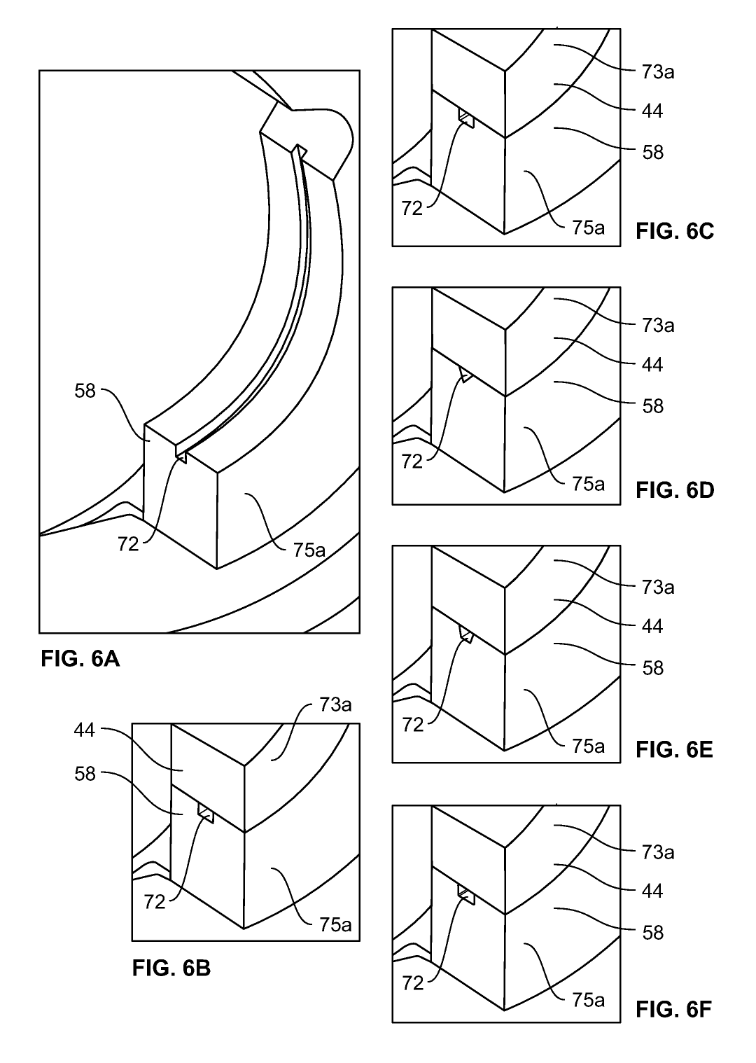

FIGS. 6A-6F show perspective views of a portion of the housing 58 and the stator core 44. The channel 72 may define a cross-section according to one of a plurality of geometric shapes, such as, but not limited to, rectangles of varying relative widths and depths as in FIGS. 6B, 6C, and 6F, a triangle as in FIG. 6D, a trapezoid as in FIG. 6E, and so on. The geometric shape of the cross-section of the channel 72 may be configured to accommodate predetermined pressure, speed, and heat transfer thresholds.

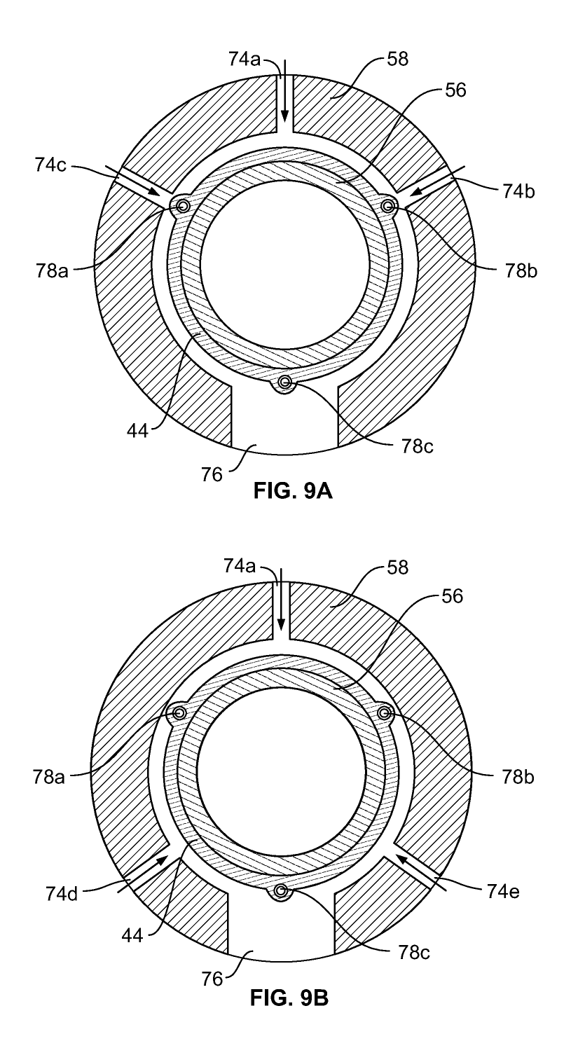

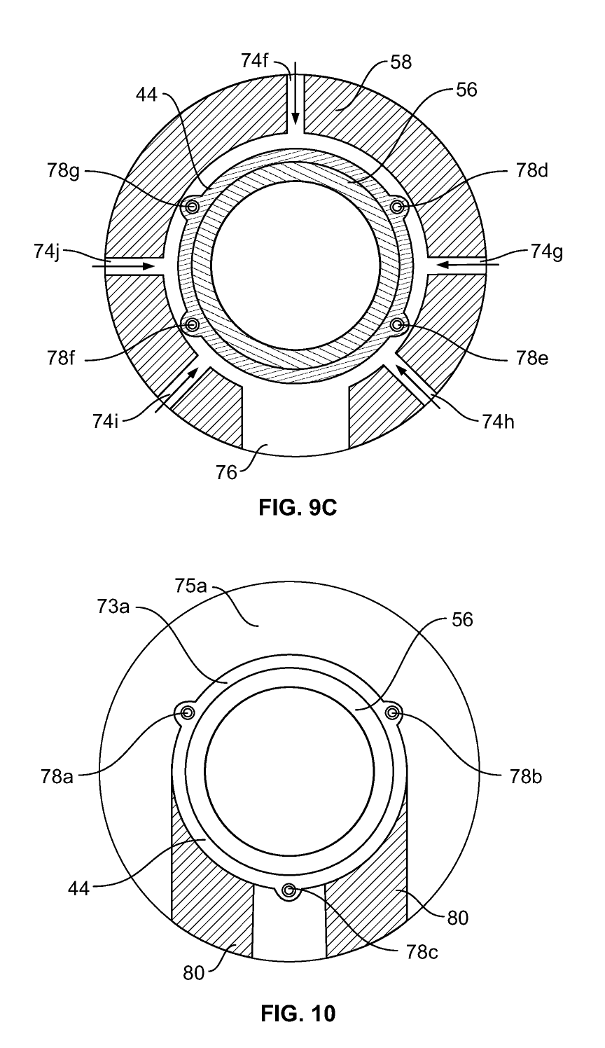

FIG. 7 shows a side view, in cross section, of a portion of the electric machine 42 and the housing 58. The coolant may enter the channel 72 using one or more channel inlets 74 defined by the housing 58. In one example, the housing 58 may define the one or more channel inlets 74a-c. As will be discussed in further detail in reference to at least FIGS. 9A-9C, the housing 58 may define the one or more channel inlets 74 as relative to one or more mounting points 78 of the stator core 44.

The pressurized coolant circulating in the channel 72 is in thermal communication with the outer surface 48 of the stator core 44 and removes heat from the stator core 44 generated, for example, due to circulation of electric current within portions of the electric machine 42. The coolant may exit the channel 72 using a channel outlet 76 defined by the housing 58. In one example the channel outlet 76 may be shared with the network of channels and passages disposed in the housing 58 and the cover 60, such as the passage 62. In yet another example, the channel outlet 76 defines a drain such that when the vehicle is on a level grade displacement of the coolant toward and through the outlet is substantially without resistance to a force of gravity.

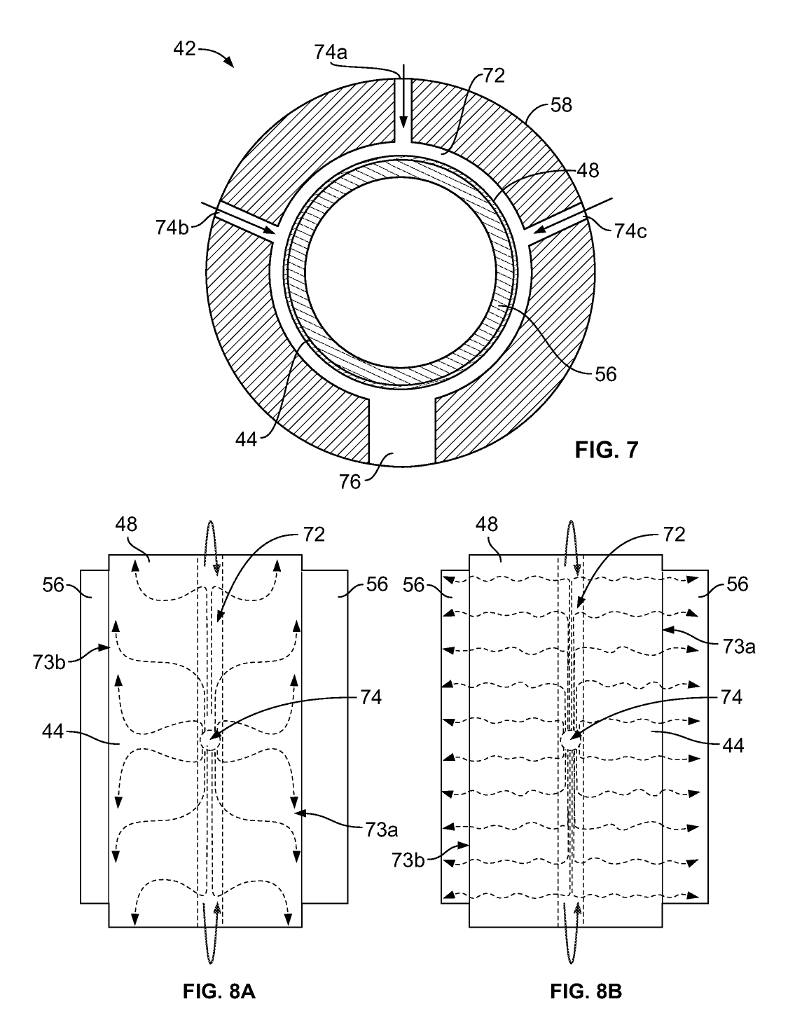

In reference to FIGS. 8A-8B, top views of a portion of electric machine 42 are shown. As indicated by a broken line in FIG. 8A, the coolant may enter the channel 72 using the one or more channel inlets 74 defined by the housing 58. The coolant circulating in the channel 72 is in thermal communication with the outer surface 48 of the stator core 44 and removes heat from the stator core 44 generated, for example, due to circulation of electric current within portions of the electric machine 42. The coolant may exit the channel 72 along the outer surface 48 of the stator core 44.

In one example, as indicated by broken line arrows in FIG. 8A, the coolant may exit the channel 72 via the clearance 70 defined by a difference in surface roughness between the outer surface 48 of the stator core 44 and the inner surface 68 of the housing 58. The channel 72 may permit seepage of the coolant into the clearance 70, such that the coolant envelops the stator core 44. In another example, the front and rear surface 73a-b of the stator core 44 and the front and rear surface 75a-b of the housing 58 may be sealed directing the pressurized coolant in the channel 72 and/or in the clearance 70 substantially toward the channel outlet 76.

Illustrated in FIG. 8B is an example configuration of a portion of the electric machine 42 without sealant along the front and rear surface 73a-b of the stator core 44 and the front and rear surface 75a-b of the housing 58 such that the coolant may exit the channel 72 along the outer surface 48 of the stator core 44. In one example, as indicated by broken line arrows in FIG. 8B, the coolant may exit the channel 72 via the clearance 70 defined by a difference in surface roughness between the outer surface 48 of the stator core 44 and the inner surface 68 of the housing 58. The channel 72 may permit seepage of the coolant into the clearance 70, such that the coolant envelops the stator core 44. As will be explained in further detail in reference to FIG. 10, the coolant may exit along at least a portion of the front and rear surface 73a-b of the stator core 44 and the front and rear surface 75a-b of the housing 58.

As described in reference to FIG. 7, the coolant circulating in the channel 72 is in thermal contact with the outer surface 48 of the stator core 44 and removes heat from the stator core 44, including by enveloping the stator core 44. Thus, a temperature of the coolant exiting the system, e.g., seeping through the clearance 70, may be higher than it was when the pressurized coolant came through the one or more channel inlets 74. In one example, a temperature of the pressurized coolant exiting the channel 72 along the outer surface 48 of the stator core 44, e.g., seeping through the clearance 70, may be lowered by passing the coolant through the heat exchanger. The transmission coolant pump may then again send the coolant back to the channel 72 repeating the process of thermal management.

The thermal management strategy outlined above contemplates varying dimension, placement, and/or geometric configuration of the channel, channel inlet, channel outlet, and other components to meet manufacturing, production, design, or other requirements, specifications, or standards. The strategy also contemplates regulating coolant flow rate, pressure, and other characteristics to achieve desirable system operation.

Shown in FIGS. 9A-9C are the side views, in cross-section, of a portion of the electric machine 42 and the housing 58. The housing 58 may define the one or more channel inlets 74a-c relative to the one or more mounting points 78a-c of the stator core 44. In one example, as shown in FIG. 9A, the housing 58 may define the one or more channel inlets 74a-c as disposed proximate at least one of the plurality mounting points 78a-c. In another example, as shown in FIGS. 9B and 9C, the housing 58 may define the one or more channel inlets 74a, 74d, 74e as disposed radially between the plurality of mounting points 78a-c and the one or more channel inlets 74f-j as disposed radially between the plurality of mounting points 78d-g, respectively. Other configurations of relative disposal of the one or more channel inlets 74 and the plurality of the mounting points 78 positioning are also contemplated.

Shown in FIG. 10 is a front view of a portion of the electric machine 42 without sealant along the front and rear surface 73a-b of the stator core 44 and the front and rear surface 75a-b of the housing 58. The coolant may exit the channel 72 along the clearance 70 and along at least a portion of the front and rear surface 73a-b of the stator core 44 and the front and rear surface 75a-b of the housing 58, such as along one or more paths 80a-b.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system for a vehicle comprising:
a transmission housing; and
an electric machine including a stator core disposed within the housing such that the housing and core define a channel, circumscribing a body of the core, configured to circulate pressurized transmission coolant and to permit seepage of the coolant into a clearance between the housing and core caused by surface roughness of the housing and core to envelop the core with the coolant.

2. The system of claim 1, wherein the housing defines a plurality of inlets configured to allow the coolant to access the channel and an outlet configured to allow the coolant to egress the channel.

3. The system of claim 2, wherein the core defines a plurality of mounting points for mounting the core to the housing, and wherein the plurality of inlets are disposed proximate to or radially between the plurality of mounting points.

4. The system of claim 2, wherein at least one of the inlets is further configured to selectively restrict coolant access to the channel and affect the enveloping of the core with the coolant.

5. The system of claim 2, wherein the outlet defines a drain such that when the vehicle is on a level grade, displacement of the coolant toward and through the outlet is substantially without resistance to a force of gravity.

6. The system of claim 5, wherein the stator core and housing further comprise a sealing material applied about a front surface and configured to direct the coolant enveloping the core toward the outlet.

7. The system of claim 1, wherein the channel is straight.

8. The system of claim 1, wherein a cross-section of the channel defines a triangle, a trapezoid, a rectangle, or a rounded rectangle.

9. The system of claim 1 further comprising a transmission coolant pump configured to supply system pressure and assist displacement of the coolant.

10. A coolant circulation system for a vehicle comprising:
a transmission housing having an inner surface defining a cavity for receiving a stator core, and defining a channel configured to circulate pressurized transmission coolant about a portion of the core and to permit seepage of the coolant into a clearance between the inner surface and core to envelop the core with the coolant.

11. The system of claim 10, wherein the housing further defines a plurality of inlets configured to allow the coolant to access the channel and an outlet configured to allow the coolant to egress the channel.

12. The system of claim 11, wherein the core defines a plurality of mounting points for mounting the core to the housing, and wherein the plurality of inlets are disposed proximate to or radially between the plurality of mounting points.

13. The system of claim 11, wherein at least one of the inlets is further configured to selectively restrict coolant access to the channel and affect the enveloping of the core with the coolant.

14. The system of claim 11, wherein the outlet defines a drain such that when the vehicle is on a level grade, displacement of the coolant toward and through the outlet is substantially without resistance to a force of gravity.

15. The system of claim 14, wherein the stator core and housing further comprise a sealing material applied about a front surface and configured to direct the coolant enveloping the core toward the outlet.

16. The system of claim 10, wherein the channel is configured to circulate the coolant about a center of the portion of the core in thermal communication with the inner surface and to permit proportional distribution of the coolant enveloping the core.

17. The system of claim 10, wherein a cross-section of the channel defines a triangle, a trapezoid, a rectangle, or a rounded rectangle.

18. The system of claim 10 further comprising a transmission coolant pump configured to maintain the circulation of the coolant.

19. A system for a vehicle comprising:
a pump configured to circulate coolant through a network of passages, wherein at least one of the passages is a channel defined by an inner surface of a transmission housing and an outer surface of a stator core, wherein the channel permits seepage of the coolant into a clearance between the inner surface and core caused by a difference in roughness of the inner surface and core to envelop the core with the coolant.

20. The system of claim 19, wherein the housing defines an outlet configured to drain the coolant enveloping the core such that when the vehicle is on a level grade, displacement of the coolant toward and through the outlet is substantially without resistance to a force of gravity.
